(19) United States
(12) Patent Application Publication
(10) Pub. No.: US 2024/0362580 A1
(43) Pub. Date: Oct. 31, 2024

(54) WAREHOUSE ITEM ASSORTMENT COMPARISON AND DISPLAY CUSTOMIZATION

(71) Applicant: Maplebear Inc. (dba Instacart), San Francisco, CA (US)

(72) Inventors: Kenneth Jason Sanchez, Orange, CA (US); Haochen Luo, Conroe, TX (US); Rishab Saraf, Redmond, WA (US); Eric Hermann, San Francisco, CA (US); Dario Fidanza, San Francisco, CA (US)

(21) Appl. No.: 18/141,394

(22) Filed: Apr. 29, 2023

(51) Int. Cl. G06Q 10/087; G06Q 30/0202

(52) U.S. Cl. CPC G06Q 10/087; G06Q 30/0202

(57) ABSTRACT

An online system evaluates different item assortments for a physical warehouse having limited capacity to stock items. Each item assortment is stocked at the physical warehouse in proportion to an assortment split weight. The items at the warehouse are available for users to order, for example to be gathered by a picker and physically delivered to users near the warehouse. Rather than display all items actually stocked at the physical warehouse to all users, the different item assortments are displayed to different users. Users may order items from the assigned item assortment and, because both item assortments are actually stocked at the physical warehouse, orders from either item assortment may be successfully fulfilled for delivery. The different user interfaces thus permit evaluation of the preferred item assortment by users while maintaining expected delivery capability and while using the same storage capacity of the physical warehouse.

### BACKGROUND

Online concierge systems provide interfaces for users to select and order items from physical warehouses. When a user submits an order, a picker obtains the orders from the warehouse and delivers the order to the user. To optimize the selection of items available at a warehouse, the online concierge systems may include various models and other systems for identifying modifications to make to the item assortment at a warehouse, suggesting that a warehouse change a current item assortment to a modified item assortment. The modified item assortment may change the quantity/number of particular items stocked by the warehouse, remove items from the warehouse, or add different items. Converting the item assortment to the modified item assortment directly may pose risks that the recommendation to change the item assortment is mistaken about the expected benefits of the modification. For example, a model may predict removing one item and substituting it for another because users are predicted to prefer the substitute item and order it more often. There may also be more complex item-item effects of changing items, such that one assortment behaves different than predicted (e.g., by a computer model suggesting the change to the item assortment). As a result, predicted benefits for changing item assortments may fail to materialize in practice. In addition, the physical warehouses are limited in space (as well as other physical constraints) and online systems typically present all items in the warehouse as available for order, limiting the ability to experiment with different item assortments in the physical warehouse itself. Because the items are stocked in a physical warehouse with limited capacity, errors in these predictions may be more difficult to correct and additional data for directly comparing the item assortments may be difficult to obtain.

### SUMMARY

In accordance with one or more aspects of the disclosure, a first item assortment (e.g., a prior item assortment for a warehouse that may be currently stocked in the warehouse), and a second item assortment (e.g., an item assortment suggested by a trained computer model) may be evaluated for stocking at the physical warehouse and to be made available for ordering on an online concierge system. Each item assortment may represent a set of items and respective quantities that would use the capacity of the warehouse and be available for order (e.g., via an online concierge system). Rather than the use of either the first item assortment or second item assortment in the specified quantities for the entire warehouse, an experiment is performed to evaluate the user interactions with the item assortments within the same physical warehouse by separately presenting the different item assortments to different users in the online concierge system. Each item assortment is stocked at the warehouse in quantities according to an assortment split weight. For example, at an assortment split weight of 50%, each item assortment is stocked at the warehouse in 50% of the specified quantities. The warehouse may thus be stocked with a “superset” of items (i.e., unique items according to an item identifier, such as a stock-keeping unit (“SKU”)) including each item assortment and in proportion to the respective item quantities specified in the different item assortments as specified by the assortment split weight.

To evaluate the respective effects of the item assortments, rather than displaying the actually-stocked items in the warehouse to users, users accessing the online concierge system are assigned to the first item assortment or second item assortment. The display elements of the user interfaces for the online concierge system are then customized according to the assigned item assortment for each user. The displayed items, responses to search queries, and other interactions may be generated for a user according to the assigned item assortment group, such that it appears to each user that the warehouse is stocked with the assigned item assortment, rather than the actually-stocked items at the warehouse. The users may be randomly assigned to each group at a ratio according to the assortment split weight. This permits the user interface and display layers of the online concierge system to perform comparisons between user interactions for the different assigned item assortment groups and simulate the different item assortments in the warehouse. The resulting user interactions between the item assortments may then be evaluated and scored to verify expected user interaction differences between the item assortments. This may be used, for example, to validate a computer model that suggested a modification to an item assortment and confirm the predicted differences in user interactions are reflected in actual user behavior when users view the different item assortments.

In addition, the performance differences between the item assortments may be used to adjust the assortment split weight. For example, initially the assortment split weight may designate 25% of the modified item assortment, and if the modified item assortment performs well, the assortment split weight may be increased to verify the performance with a larger set of users.

By assigning users to different subgroups of the actually-stocked items (i.e., the different item assortments) and making the different subgroups available in the displays, the online system can differentiate and assess the “in-practice” differences of the item assortments while still using the same warehouse space (e.g., without requiring additional warehouse capacity). After evaluation, the warehouse may then be stocked only with the stronger-performing item assortment according to the specified item quantities.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 shows an example application of an inventory interaction model, in accordance with one or more embodiments.

FIG. 4 shows an example for evaluating item assortments for a warehouse, in accordance with one or more embodiments.

FIG. 5 is a flowchart for a method of evaluating item assortments in a physical warehouse with modified user interfaces, in accordance with some embodiments.

### DETAILED DESCRIPTION

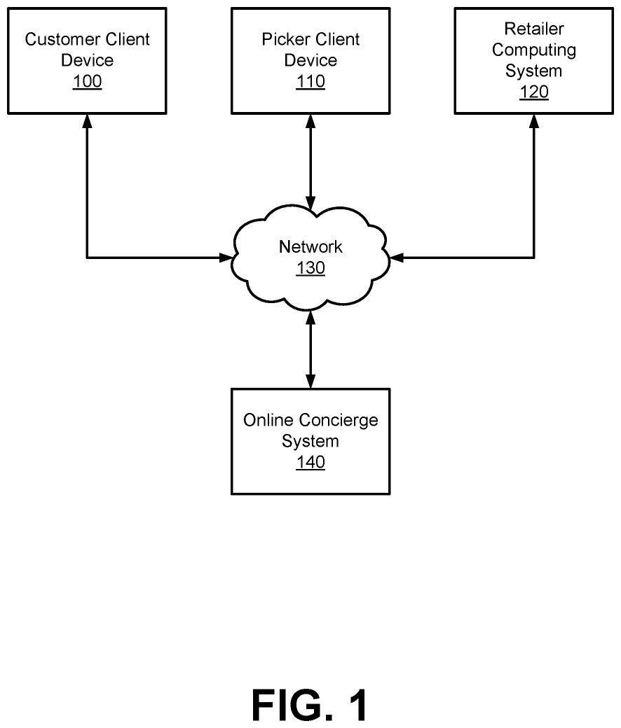

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

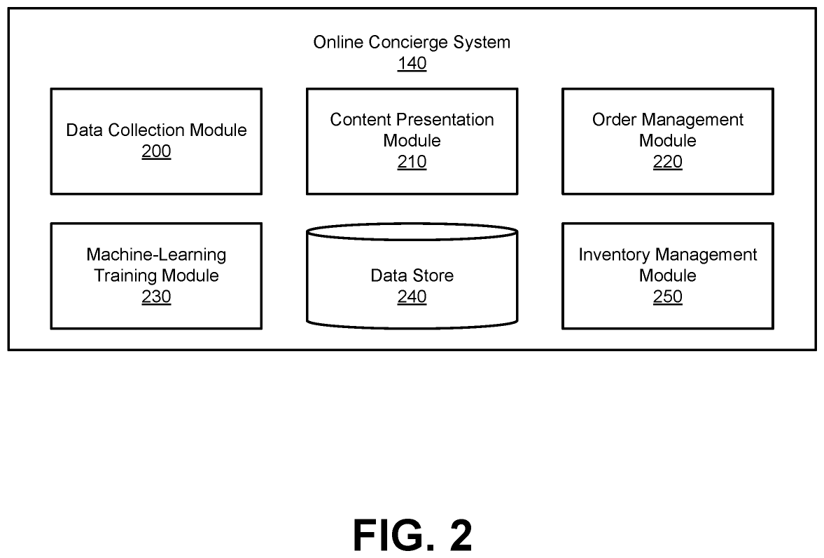

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

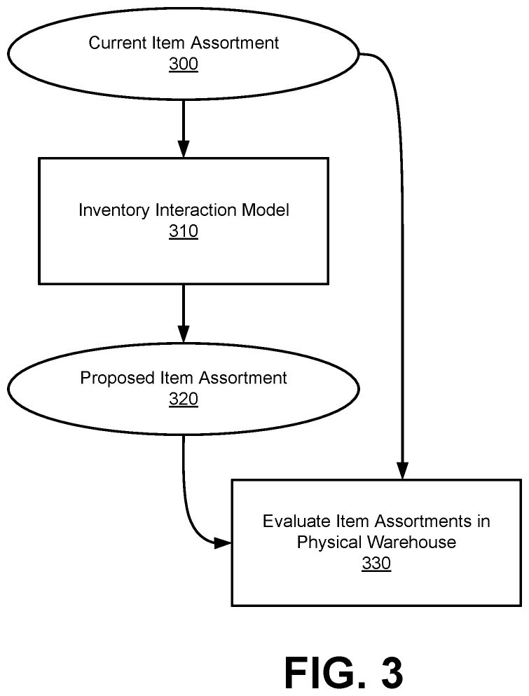

In some embodiments, the content presentation module 210 coordinates with the inventory management module 250 for the evaluation of different content item assortments at a particular physical location. Each content item assortment is a different set of items that may be available at a location. To evaluate the different item assortments at a location, users accessing the online concierge system 140 and requesting to view items and place orders for that particular location are assigned to one of the item assortments being evaluated. When viewing user interface elements and other components, the content presentation module 210 generates user interface elements based on the assigned item assortment. For example, items shown as available at the location, items displayed in response to a search query, promotions for items at the location, and so forth, may each be based on the assigned item assortment. As discussed further below, the actual physical location may be stocked with items specified by each of the item assortments. As such, the content presentation module 210 presents items available to order that may not include all actually-stocked items at the location, and instead may be based on the assigned item assortment for the evaluation. Because both item assortments are actually stocked at the warehouse, users viewing items for the assigned item assortment may proceed with normal user interfaces with respect to that item assortment, which may include placing orders that can be fulfilled at that warehouse. These and other features are further discussed below, particularly with respect to FIGS. 3-5.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning model may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

The inventory management module 250 provides inventory management information to retailers and may be used in the management of inventory for physical retailer locations and/or warehouses. Though shown as a component of the online concierge system 140 in FIG. 2, in some embodiments, aspects of the inventory management module 250 may be incorporated in systems used by the retailer in managing physical warehouses/locations that stock items available for purchase and/or for orders coordinated by the online concierge system 140. Each location in which items are stored may have a limited amount of space available and be capable of storing different types of items. For grocery retailers as an example, in addition to different geographical locations, different grocery retailers may have different floorspace available for stocking items, may have different departments or capacities for stocking different items (e.g., one grocer may have no area for frozen items, while another has an extensive freezer section), may have different clienteles, and so forth. The inventory management module 250 may analyze user interactions, orders, and items to determine predictions for managing inventory at these physical locations. The inventory management module 250 in various embodiments may provide information relating to warehouse locations, items to stock at these locations and at what quantities, and so forth, to optimize various metrics of the online concierge system 140 and of an operator of the warehouse locations.

As one of these functions, the inventory management module 250 recommends modifications to items and item quantities stocked at and offered by a warehouse (e.g., a particular retailer location) over time. For example, the inventory management module 250 may suggest items to be removed and/or included in a physical warehouse, such as at a retailer's physical location. The collection of items included in the warehouse may be referred to as the “item assortment” at the warehouse. In addition to the particular items (e.g., individual item identifiers or SKUs), each item may also be associated with a quantity representing a number of each item to be stocked at the warehouse or historical/expected sales of the item over a period of time. Determining which items to add or remove from an item assortment may be difficult as user interactions with items may be affected by other items in the item assortment and the items offered at other locations. To provide effective modeling of user interactions with individual items or an item assortment, the inventory management module 250 may use an inventory interaction model that predicts user interactions for a target item (e.g., a candidate item for addition to an assortment) based on information about the item along with other items in the assortment (e.g., co-located items in the warehouse). Various types of item interaction models using different types of features may be used in different embodiments for predicting item interactions and selecting assortments in different embodiments.

In addition to suggesting modifications to item assortments, the inventory management module 250 may also perform comparative evaluations of item assortments stocked for a physical warehouse. For example, a first item assortment may represent a set of items currently stocked at a warehouse, and a second item assortment may represent a set of items suggested by an inventory interaction model as a modification to the item assortment stocked at the warehouse. Rather than directly adopt the second item assortment to replace the first item assortment for stocking the warehouse, the inventory management module 250 may coordinate stocking of the warehouse with both the first item assortment and the second item assortment to determine comparative metrics between the item assortments. The comparative metrics may be used to confirm whether the second item assortment performs as expected relative to the first item assortment. In many circumstances, predictions from the inventory interaction model may be based, e.g., on co-located items, items at nearby locations, and so forth, and may have limited training data for direct comparisons of different item assortments for the same physical warehouse at the same time. As such, the evaluation of the item assortments may be used to verify the efficacy of the model and/or to provide additional training data for further training the model as discussed below.

FIG. 3 shows an example application of an inventory interaction model 310, in accordance with one or more embodiments. Application of the inventory interaction model 310 may be used, for example, to suggest a modification of a current item assortment 300. The particular structure of the inventory interaction model 310 may vary in different embodiments. In general, the inventory interaction model 310 may receive features describing items and the location at which the items will be stocked to predict likely user interactions (e.g., orders of the item, placing the item in a shopping list, interacting with a page describing the item, etc.). In additional examples, the inventory interaction model 310 may evaluate items in view of other items co-located at a location, such that items may be iteratively considered for addition to an item assortment. A proposed item assortment 320 may then be determined based on predictions from the inventory interaction model 310, for example, by removing items from the current item assortment 300 that perform relatively poorly (e.g., with respect to user orders or revenue relative to the amount of space occupied in the warehouse) and adding a number of items based on predictions from the inventory interaction model 310. In some embodiments, the proposed item assortment 320 may include items in common with the current item assortment 300. In addition, the respective item assortments may specify the individual items to be stocked and may also specify a number of the items to stock or an expected order frequency of the items (e.g., the number of times within a particular time duration that an item is expected to be ordered by users).

In some embodiments, the proposed item assortment 320 may be determined by other means (e.g., other types of models) and may include involvement with a human operator (e.g., associated with the retailer). In general, the proposed item assortment 320 may represent an item assortment to be evaluated with respect to the current item assortment 300, each of which may represent competing options for completely stocking the warehouse (e.g., with the items and item quantities specified in the respective item assortments). As discussed further below, to evaluate 330 the item assortments, in accordance with one or more embodiments, the item assortments are then stocked together at the warehouse in lower quantities than the quantities specified in the item assortments.

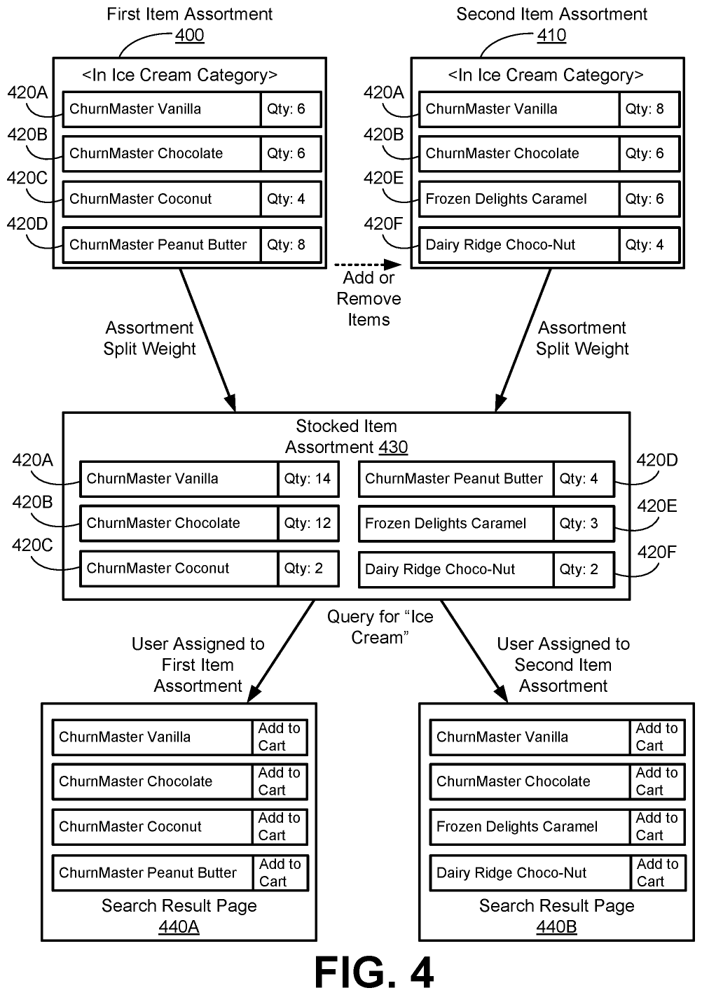

FIG. 4 shows an example for evaluating item assortments for a warehouse, in accordance with one or more embodiments. The evaluation of the item assortments may be performed in one or more embodiments, by components of the online concierge system 140, for example by the inventory management module 250 in conjunction with the content presentation module 210. The item assortments to be evaluated, such as the first item assortment 400 and second item assortment 410 may be any item assortments suitable for evaluation at the same physical warehouse. As discussed with respect to FIG. 3, the item assortments may represent a current or “prior” item assortment of a warehouse (e.g., the first item assortment 400) and a proposed or modified item assortment (e.g., the second item assortment 410) relative to the “prior” item assortment. The first item assortment 400 and second item assortment 410 may each include respective items and quantities to be stocked at the warehouse, such that each item assortment may be intended to designate a complete set of items stocked at the warehouse in the specified quantities. In some examples, the second item assortment 410 differs from the first item assortment 400 in the addition or removal of individual items (e.g., particular items or SKUs), and may also differ in the quantity of items for a particular item.

In the example of FIG. 4, individual items and quantities are illustrated for a particular category of frozen item (i.e., ice cream); in practice, the item assortments may include additional items and additional types of items. In this example, the first item assortment 400 shows quantities of each item 420A-D, in particular specifying a quantity of 6 of item 420A, 6 of item 420B, 4 of item 420C, and 8 of item 420D. Similarly, the second item assortment 410 shows quantities of items 420A-B, E-F. Relative to the first item assortment 400, in this example, the second item assortment removes items 420C-D and adds items 420E-F, keeps the quantity of item 420B the same, and modifies the quantity of item 420B. As discussed above and shown in this example, the second item assortment 410 may use the same space in the warehouse, such that stocking the warehouse with either item assortment in the designated quantities may be expected to substantially use the available capacity of the warehouse at the location.

To evaluate and compare the item assortments at the location, each of the item assortments is stocked in the warehouse at a proportion defined by an assortment split weight. It may not be preferable to stock the warehouse on a more long-term basis with the combination of item assortments for various reasons—each item stocked in the warehouse occupies an amount of the limited space in the warehouse and stocking one item may prevent stocking another. The limited space may create various costs for stocking smaller quantities of less-preferred item assortments. Items may, in some circumstances, be considered by users as complete substitutes for other items, such that only one of the items may be stocked and effectively satisfy user demand; in other cases, similar items may not be considered suitable substitutes by users, such that insufficient stock of a preferred item may lose the opportunity to offer that item to users who are unwilling to replace it with the similar item. There may also be efficiencies in provisioning higher quantities of fewer items for the warehouse, which may include reduced spoilage, reduced shipping costs, tracking and other labor in physically organizing the items, and so forth. As such, the first item assortment and second item assortment may both be stocked (at reduced quantities) for a time duration to evaluate the performance of the item assortments. Depending on the comparative performance, various actions may be taken, including selecting the better-performing item assortment for stocking the warehouse.

The assortment split weight specifies the relative weight of each item assortment in stocking the warehouse for the time duration of the evaluation. For example, the assortment split weight may specify a 50% weight for the first item assortment and a 50% weight for the second item assortment. The warehouse may then be stocked with items at the specified assortment split weight of the item quantities specified in, respectively, the first item assortment and the second item assortment. In the example of FIG. 4, the assortment split weight is 50%/50%, such that the stocked item assortment 430 at the warehouse is equally weighed with 50% of the item quantities specified in the first item assortment 400 and 50% of the item quantities of the second item assortment 410. For items that are included in each item assortment, the combined quantities (e.g., as modified by the respective assortment split weight) may be stocked. As such, the stocked item assortment 430 includes quantities of items 420A-B combining contributions from each item assortment, while items 420C-F include quantities as a respective portion from each item assortment.

Although this example shows an assortment split weight of 50%/50%, the assortment split weight may be any value suitable for evaluating the item assortments. In some embodiments, the assortment split weight may also be modified over time. In one or more embodiments the assortment split weight is initially weighed predominantly towards one item assortment and may later be modified towards another item assortment. For example, the first item assortment may be the current item assortment for a warehouse, and the second item assortment may be a proposed item assortment based on model predictions. The assortment split weight may primarily specify the current item assortment (e.g., 75%/25%) to evaluate the proposed modification to the item assortment before significantly changing the item assortment actually stocked at the warehouse. After the item assortments are evaluated, if the proposed item assortment performs well relative to the current item assortment, the assortment split weight may be adjusted to further evaluate the item assortments with an increased portion of the stocked items from the proposed item assortment (e.g., to 50%/50% from 75%/25%).

After stocking the item assortments, the stocked item assortment 430 at the warehouse may then be considered to a “superset” of items including the items from each of the item assortments. To evaluate the different item assortments, users accessing the online concierge system to place orders of items for delivery from the warehouse location are assigned to one of the item assortments. The user interfaces and interface elements for each user then present items from the assigned item assortment to the user. In the example shown in FIG. 4, a user query of “ice cream” may generate a different search result page depending on the assigned item assortment. A user assigned to the first item assortment is provided a search result page 440A that includes items of the first item assortment 400, while a user assigned to the second item assortment is provided a search result page 440B that includes items of the second item assortment 410. As such, the user interface elements, such as the items viewable when browsing categories, items selected responsive to search queries, items provided as part of a promotion, items suggested for recipes, and so forth, may be based on the assigned item assortment for the user. In this sense, the user interface layer of the online concierge system may provide a way to perform an experiment with the stocked item assortment 430 that simulates the different item inventories at the location at the same time and provided to the same audience of users.

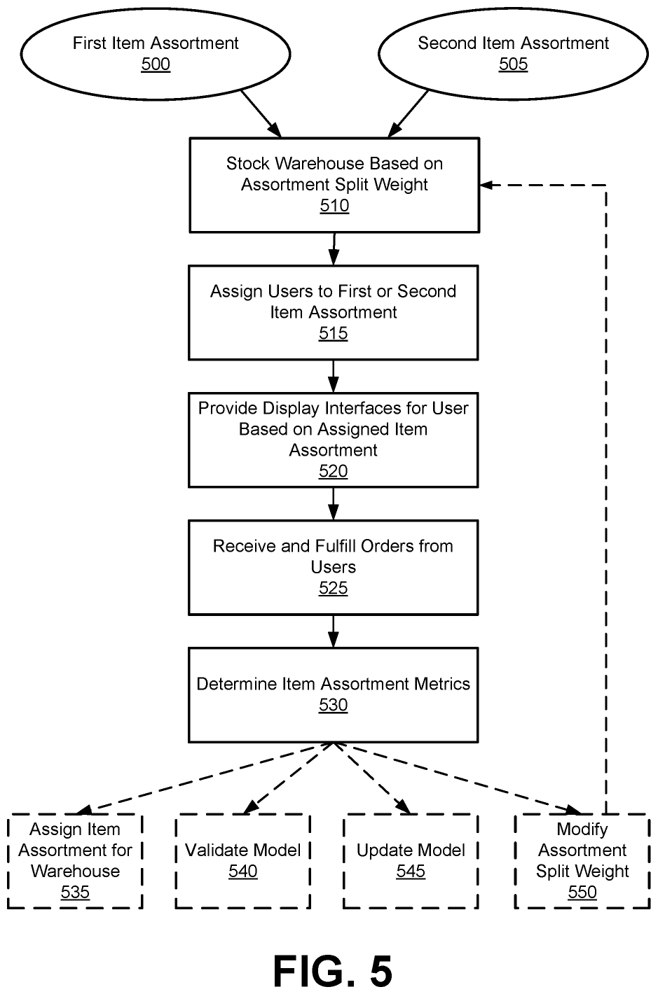

In one or more embodiments, the users may be selected randomly for assignment to each of the item inventories. In circumstances in which the assortment split weight is not equal (e.g., not 50%/50%), the users accessing the online concierge system to place an order may be assigned to each item assortment at a frequency based on the assortment split weight. As such, users may be assigned to item inventories in proportion to the amount that the assigned item assortment was stocked in the warehouse. This may align the expected orders for an item with the extent to which the item is stocked at the warehouse (e.g., relative to a “full” quantity as specified in the item assortment). For example, an item assortment that is stocked at a 75% portion of its specified quantities may be assigned a corresponding portion of 75% of the users. As discussed with respect to FIG. 5, user orders of items based on the assigned user interfaces may then be used to evaluate the respective item assortments.

FIG. 5 is a flowchart for a method of evaluating item assortments in a physical warehouse with modified user interfaces, in accordance with some embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

Initially, the method may identify item assortments to be evaluated, such as a first item assortment 500 and a second item assortment 505. As discussed above, e.g., with respect to FIG. 3, the first item assortment 500 may represent a “prior” item assortment stocked at a warehouse and the second item assortment 505 may represent a proposed or suggested item assortment being considered for the warehouse to transition to. However, the first item assortment 500 and second item assortment 505 may represent any item assortments to be evaluated and thus may not be related to any previous set of items available at a warehouse location. Each of the first item assortment 500 and second item assortment 505 are then stocked at the warehouse with a respective portion of the item quantities according to the assortment split weight. In some embodiments, “stocking” may include sending instructions to an operator or manager of the warehouse indicating the total set of items and respective quantities to be stocked at the location, or otherwise causing or directing that the set of items available for fulfillment at the location to include items from the first item assortment 500 and second item assortment 505. In addition, while the assortment split weight is discussed with respect to a portion of specified quantities of the items in the item assortments, in some situations, the item assortments may not specify a quantity of items. In these circumstances, the items in the respective item assortments may be stocked at the warehouse using the assortment split weight on another basis, such as with respect to the capacity of the warehouse. For example, each item assortment may be allocated a physical space or capacity of the warehouse according to the assortment split weight 510 and items from the item assortment are stocked according to the allocated space/capacity.

Users may then be assigned 515 to the item assortments (e.g., the first item assortment or second item assortment) to evaluate the effect of each item assortment on user interactions. The users may be assigned randomly to the item assortments and may be assigned to the item assortments at a frequency or ratio based on the assortment split weight. This may mean that the expected frequency that users order items from the respective item assortments are aligned with the extent to which each item assortment was stocked at the warehouse, enabling successful fulfillment of orders from the users. In addition, by randomly assigning users to the different item assortments, the different responses of users to the different viewed item assortments may represent a randomized “experiment” that allows effective comparison of the item assortments. In some embodiments, users may be assigned 515 an item assortment when each user accesses the online concierge system to view or order items from the location/warehouse. In other embodiments, users may be assigned an item assortment in advance of an access to select items for an order.

Using the assigned item assortment, the display interfaces provided 520 to the user may then display items based on the assigned item assortment. As discussed above, display elements such as items that appear to be available to order, results for search queries, etc., are determined based on the assigned item assortment. For example, items that are stocked in the warehouse but are not in the assigned item assortment are prevented from display to the user. Stated another way, the assigned item assortment may be presented to users to simulate that the location only includes the assigned item assortment. Using the display interfaces, users may select items from the assigned item assortment to create orders for the warehouse. The orders are then received and orders are fulfilled 525 from the warehouse. Because each of the item assortments is actually stocked at the warehouse, pickers may successfully fulfill orders from each of the item assortments at the location. Together, this permits the item assortments to be evaluated with respect to one another (with respect to user interactions with the item assortments) while using the limited capacity of the warehouse in conjunction with effective order fulfillment.

Then, based on the orders of users for the items in each item assortment, one or more item assortment metrics may be determined 530 for the item assortments. The metrics may include any suitable measurements of user interactions with the different item assortments, such as the number of items ordered, the revenue for the respective item assortments, expected profit (e.g., revenue adjusted by related costs of stocking the item assortments), and so forth. The metrics may also be calculated for the item assortments as comparative metrics between the item assortments, for example, determining a ratio of the metrics between the item assortments. In one or more embodiments, the metrics may also be adjusted based on the relative ratio or portion of users assigned to each item assortment (e.g., which may be based on the assortment split weight). For example, in some embodiments users may be assigned to the first item assortment at a ratio of 2:1 compared to the first item assortment. In this example, a metric describing total revenue for the item assortments may also be adjusted 2:1 to account for the different number of users assigned to the first item assortment relative to the second item assortment. The particular metrics and calculation thereof may vary in different embodiments and may include any suitable metrics for evaluating the item assortments for the warehouse.

In addition to determining 530 the metrics to evaluate the item assortments, the item assortment metrics may also be used to take various actions. For example, based on the metrics, the assortment split weight may be modified 550, for example, to perform an additional evaluation of the item assortments and increase the weight for the better-performing item assortment. As an additional example, the metrics may also be used to select one of the item assortments and assign 535 the item assortment for the warehouse, such that the warehouse is stocked according to the selected item assortment.

In embodiments in which at least one of the item assortments is determined based on a computer model, such as an item interaction model, the comparative performance of the item assortments may be used to validate 540 or update 545 the model. For example, when the model's predictions about the item assortment performance are consistent with the performance of the item assortment (e.g., when the second item assortment is predicted to have improved user interactions relative to the first item assortment), the item assortment metrics may be used to validate 540 the model with respect to its predictions. When the model prediction is relatively similar, validation of the model may result in further application of the model, for example to additional locations or to item assortments, without performing additional item assortment evaluation. In some embodiments, the performance metrics may be used to update 545 the model, for example by using the user interactions with the different item assortments as further training data to refine the model based on the results of the different item assortments offered at the location at the same time. As such, in addition to directly using the metrics to further adjust the item assortment at the location, the metrics may also be used to evaluate and/or improve a model that predicted outcomes for the item assortments.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
identifying a first item assortment and a second item assortment, the first and second item assortments describing a respective set of items and quantities thereof to stock a physical warehouse having a limited capacity for item storage;
stocking the physical warehouse with the first item assortment and second item assortment based on an assortment split weight specifying a portion of the respective item quantities to stock for the first item assortment and the second item assortment;
assigning a plurality of users to the first item assortment or the second item assortment;
providing user interface elements for display to respective devices of the plurality of users for placing an order at the physical warehouse, the user interface elements for each user of the plurality of users being based on the assigned item assortment;
receiving orders from the plurality of users; and
determining one or more comparative metrics between the first and second item assortment based on the received orders from the plurality of users and the respective assigned item assortment.

2. The method of claim 1, wherein providing the user interface elements to each user in the plurality of users includes displaying only items to the user that are in the assigned item assortment.

3. The method of claim 1, wherein assigning the plurality of users to the first item assortment or the second item assortment assigns users to the respective item assortments at a ratio matching the assortment split weight.

4. The method of claim 1, wherein each user of the plurality of users is assigned to the first item assortment or the second item assortment responsive to receiving a request from the user to view items available for order at the physical warehouse.

5. The method of claim 1, wherein the plurality of users is randomly assigned to the first item assortment or the second item assortment.

6. The method of claim 1, wherein providing the user interface elements includes providing search results for a search query based on the assigned item assortment.

7. The method of claim 1, further comprising:
generating the second item assortment with a trained computer model applied to the first item assortment.

8. The method of claim 7, further comprising:
training the computer model based on the received orders for the first item assortment and the received orders for the second item assortment.

9. The method of claim 1, further comprising:
modifying the assortment split weight based on the comparative metrics.

10. A non-transitory computer-readable medium having instructions encoded thereon that, when executed by a processor, cause the processor to perform steps comprising:
identifying a first item assortment and a second item assortment, the first and second item assortments describing a respective set of items and quantities thereof to stock a physical warehouse having a limited capacity for item storage;
stocking the physical warehouse with the first item assortment and the second item assortment based on an assortment split weight specifying a portion of the respective item quantities to stock for the first item assortment and the second item assortment;
assigning a plurality of users to the first item assortment or the second item assortment;
providing user interface elements for display to respective devices of the plurality of users for placing an order at the physical warehouse, the user interface elements for each user of the plurality of users being based on the assigned item assortment;
receiving orders from the plurality of users; and
determining one or more comparative metrics between the first and second item assortment based on the received orders from the plurality of users and the respective assigned item assortment.

11. The non-transitory computer-readable medium of claim 10, wherein providing the user interface elements to each user in the plurality of users includes displaying only items to the user that are in the assigned item assortment.

12. The non-transitory computer-readable medium of claim 10, wherein assigning the plurality of users to the first item assortment or the second item assortment assigns users to the respective item assortments at a ratio matching the assortment split weight.

13. The non-transitory computer-readable medium of claim 10, wherein each user of the plurality of users is assigned to the first item assortment or the second item assortment responsive to receiving a request from the user to view items available for order at the physical warehouse.

14. The non-transitory computer-readable medium of claim 10, wherein the plurality of users is randomly assigned to the first item assortment or the second item assortment.

15. The non-transitory computer-readable medium of claim 10, wherein providing the user interface elements includes providing search results for a search query based on the assigned item assortment.

16. The non-transitory computer-readable medium of claim 10, wherein the non-transitory computer-readable medium further has instructions encoded thereon that, when executed by the processor, cause the processor to perform steps comprising:
generating the second item assortment with a trained computer model applied to the first item assortment.

17. The non-transitory computer-readable medium of claim 16, wherein the non-transitory computer-readable medium further has instructions encoded thereon that, when executed by the processor, cause the processor to perform steps comprising:
training the computer model based on the received orders for the first item assortment and the received orders for the second item assortment.

18. The non-transitory computer-readable medium of claim 10, wherein the non-transitory computer-readable medium further has instructions encoded thereon that, when executed by the processor, cause the processor to perform steps comprising:
modifying the assortment split weight based on the comparative metrics.

19. A system, comprising:
a processor configured to execute instructions; and
a non-transitory computer-readable medium having instructions encoded thereon that, when executed by the processor, cause the processor to perform steps comprising:
identifying a first item assortment and a second item assortment, the first and second item assortments describing a respective set of items and quantities thereof to stock a physical warehouse having a limited capacity for item storage;
stocking the physical warehouse with the first item assortment and the second item assortment based on an assortment split weight specifying a portion of the respective item quantities to stock for the first item assortment and the second item assortment;
assigning a plurality of users to the first item assortment or the second item assortment;
providing user interface elements for display to respective devices of the plurality of users for placing an order at the physical warehouse, the user interface elements for each user of the plurality of users being based on the assigned item assortment;
receiving orders from the plurality of users; and
determining one or more comparative metrics between the first and second item assortment based on the received orders from the plurality of users and the respective assigned item assortment.

20. The system of claim 19, wherein providing the user interface elements to each user in the plurality of users includes displaying only items to the user that are in the assigned item assortment.
